(19) United States
(12) Patent Application Publication
(10) Pub. No.: US 2015/0149415 A1
(43) Pub. Date: May 28, 2015

(54) Rollback Mechanism for Linear Tape File Systems

(71) Applicant: International Business Machines Corporation, Armonk, NY (US)

(72) Inventors: Masayuki Iwanaga, Tiba-ken (JP); Yumiko Ohta, Kanagawa (JP); Yutaka Oishi, Kanagawa (JP)

(73) Assignee: International Business Machines Corporation, Armonk, NY (US)

(21) Appl. No.: 14/087,793

(22) Filed: Nov. 22, 2013

(51) Int. Cl. G06F 11/14; G06F 17/30

(52) U.S. Cl. CPC G06F 11/1469; G06F 17/30321
USPC 707/684

(57) ABSTRACT

A mechanism is provided for restoring a file recorded on a storage medium to a previous version of the file. At least two different versions of a file recorded on the storage medium are presented to a user via a graphical user interface, where the at least two different versions of the file are identified from at least two different indexes recorded on the storage medium. Responsive to a selection of the previous version of the file from the at least two different versions of the file, the file is restored to the previous version of the file by recording a new index on the storage medium for the file that matches an index of the file associated with the previous version of the file.

### BACKGROUND

The present application relates generally to an improved data processing apparatus and method and more specifically to a rollback mechanism for linear tape file systems.

Linear Tape File System (LTFS) refers to both the format of data recorded on magnetic tape media and the implementation of specific software that uses this data format to provide a file system interface to data stored on magnetic tape. The Linear Tape File System format is a self-describing tape format developed by International Business Machines (IBM) Corporation of Armonk, N.Y. to address tape archive requirements. The LTFS Format specification defines the organization of data and metadata on tape, where the files are stored in a hierarchical directory structure. Data tapes written in the LTFS Format can be used independently of any external database or storage system allowing direct access to file content data and file metadata. This format makes it possible to implement software that presents a standard file system view of the data stored in the tape medium. This file system view makes accessing files stored on the LTFS formatted media similar to accessing files stored on other forms of storage media such as disk or removable flash drives.

As mentioned above, in LTFS, in addition to the storing of the content of a file itself into a tape medium, metadata related to the file is also stored. This metadata, which may include data referred to as an index used for identifying the file, the name of the file, etc., is stored into the tape medium, such as in an Extendible Markup Language (XML) file format. In the existing LTFS Format, it is not permitted to divide an index into a plurality of XML files. The task of storing an index on the tape medium is referred to as a “sync” task or operation.

### SUMMARY

In one illustrative embodiment, a method, in a data processing system, is provided for restoring a file recorded on a storage medium to a previous version of the file. The illustrative embodiment presents at least two different versions of a file recorded on the storage medium to a user via a graphical user interface. In the illustrative embodiment, the at least two different versions of the file are identified from at least two different indexes recorded on the storage medium. Responsive to a selection of the previous version of the file from the at least two different versions of the file, the illustrative embodiment restores the file to the previous version of the file by recording a new index on the storage medium for the file that matches an index of the file associated with the previous version of the file.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE SEVERAL VIEWS OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 illustrates the state of a tape medium immediately after formatting by means of the LTFS format;

FIG. 2 illustrates the state of a tape medium after writing data to the tape medium a plurality of times;

FIG. 3 is an example diagram of a distributed data processing system in which aspects of the illustrative embodiments may be implemented;

FIG. 4 is an example block diagram of a computing device in which aspects of the illustrative embodiments may be implemented;

FIG. 5 depicts a functional block diagram of a rollback mechanism for recovering content of a file on a linear tape medium back to a previous state at a user-identified point in time in accordance with an illustrative embodiment;

FIG. 6 depicts an exemplary graphical user interface in accordance with an illustrative embodiment; and

FIG. 7 depicts a flowchart of the operation performed by a rollback mechanism in accordance with an illustrative embodiment.

### DETAILED DESCRIPTION

Again, a linear tape file system (LTFS) makes accessing files stored on a LTFS formatted media similar to accessing files stored on other forms of storage media such as disk or removable flash drives. In LTFS, since data is written linearly to the tape medium, a new write operation will never be performed at a position where a previous write operation has been performed. For example, even when a file that is already recorded on the tape medium is changed, the original file is not deleted and rewritten. Rather, only the difference is written to the tape medium and the index is updated to reflect the portions of the original file and the new data that comprise the file after the changes. As another example, when a file is deleted from the tape medium, the file is not actually removed from the tape medium. Rather, the index is merely updated with an indication that the file is no longer valid. Further, in both of these examples, the original index is not updated. Rather, a new index is written to the tape medium thereby replacing the older index. For this reason, because of the nature of LTFS, there is a possibility of recovering a file to a previous state.

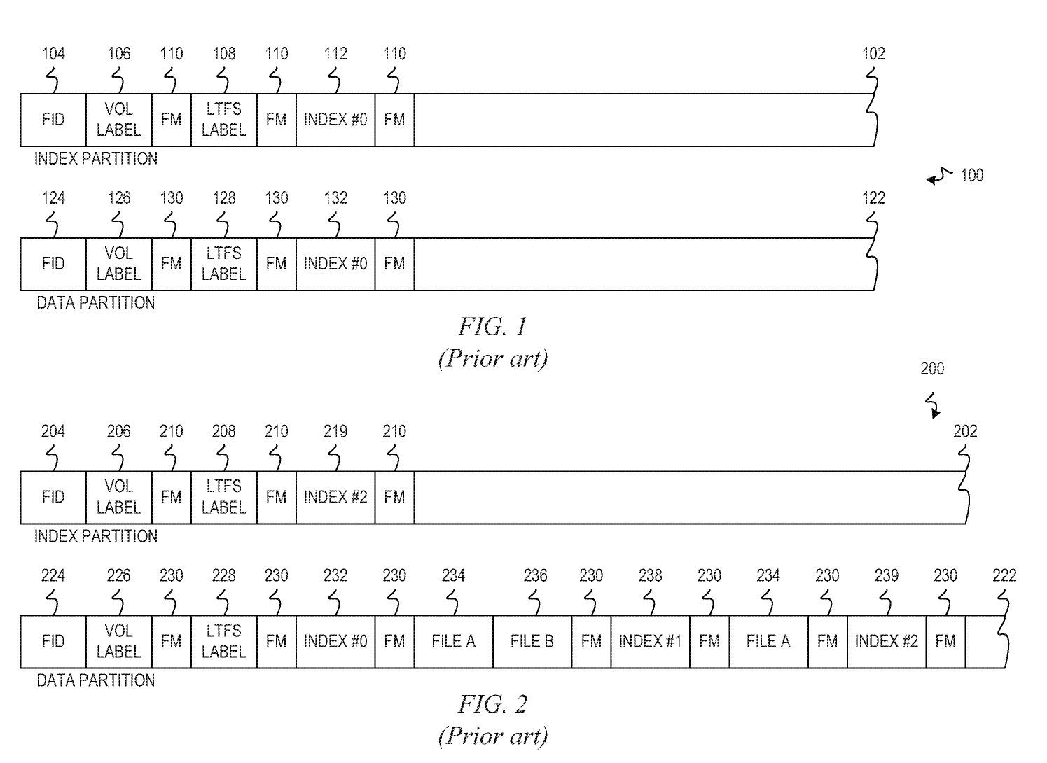

FIG. 1 illustrates the state of a tape medium immediately after formatting by means of the LTFS format. Tape medium 100 is divided into Index Partition (IP) 102 and Data Partition (DP) 122. IP 102 and DP 122 comprise Format Identification Dataset (FID) 104 and 124, respectively, that are a special kind of data written at the head of a tape medium when a tape drive initializes the tape medium. FID 104 and 124 comprises information on the number of partitions on the tape medium, information on the capacity of each of the partitions, or the like. IP 102 and DP 122 also comprise Volume Label (VOL Label) 106 and 126, respectively, that are labels in a general format specified by the American National standards Institute (ANSI). IP 102 and DP 122 additionally comprise LTFS Label 108 and 128, respectively, which are labels specified in the LTFS format and comprise information on the specific version of the LTFS format in conformity with which the tape medium has been formatted. IP 102 and DP 122 further comprise File Marks (FM) 110 and 130, respectively, that are marks typically used in a tape medium for the purpose of locating the start position of data (for data seek). Finally, IP 102 and DP 122 comprise Index #0 112 and 132, respectively, that are original indexes written at the time of formatting. Although, Index #0 112 and 132 do not comprise any unique-to-file information because no file exists at initial formatting, information such as the volume name of the tape medium is written to Index #0 112 and 132 for storage.

FIG. 2 illustrates the state of a tape medium after writing data to the tape medium a plurality of times. As with tape medium 100, tape medium 200 is divided into Index Partition (IP) 202 and Data Partition (DP) 222. IP 202 and DP 222 comprise Format Identification Dataset (FID) 204 and 224, respectively, that are a special kind of data written at the head of a tape medium when a tape drive initializes the tape medium. FID 204 and 224 comprises information on the number of partitions on the tape medium, information on the capacity of each of the partitions, or the like. IP 202 and DP 222 also comprise Volume Label (VOL Label) 206 and 226, respectively, that are labels in a general format specified by the American National standards Institute (ANSI). IP 202 and DP 222 additionally comprise LTFS Label 208 and 228, respectively, which are labels specified in the LTFS format and comprise information on the specific version of the LTFS format in conformity with which the tape medium has been formatted. IP 202 and DP 222 further comprise File Marks (FM) 210 and 230, respectively, that are marks typically used in a tape medium for the purpose of locating the start position of data (for data seek). Still further, DP 222 comprise Index #0 232 that is the original index written at the time of formatting.

As illustrated in FIG. 2, deleted data and overwritten information remains in tape medium 200 without being deleted and/or erased. That is, at a first time interval, File A 234 and File B 236 are written to DP 222 along with Index #1 238 where at the same time an Index #1 is written, which overwrites Index #0, to IP 202 (not shown). At a next time interval, File A 234 is updated alone with Index #2 239 where at the same time Index #2 219, which overwrites Index #1. is written to IP 202. The update to File A 234 may be an added portion or a complete rewrite of the file, either of which are indicated in Index #2 239 and Index #2 219. Still further, regardless of whether data changes in any file, indexes may be written to IP 202 and DP 222 at regular time intervals.

Therefore, in a tape medium, every previous (past) data remains without being deleted or erased. However, since the indexes of a tape medium are updated at regular time intervals, then, if the tape medium were written every hour of every day for a year, there may be 8,760 indexes on the tape medium. Consequently, when an LTFS user wants to recover the content of a file back to a previous state before updating or when an LTFS user wants to recover a file that was deleted by mistake, the user would have to select from 8,760 indexes in order to choose an appropriate index and file version, which may be an arduous task.

The illustrative embodiments provide a rollback mechanism for linear tape file systems that provide the user with an easy means to recover the content of a file back to a previous state at a user-identified point in time. The mechanism utilizes a plurality of components that are graphically presented to the user that allows the user to select from a plurality of year/month/day/time ranges to which a file can be recovered. With each year/month/day/time range available to be selected by the user, there is a different version of the file, which may be provided as a preview to the user. With the selection of a version of the file at one of the year/month/day/time ranges, the mechanism of the illustrative embodiments returns the file to the previous version by updating the index to reflect the selected previous state.

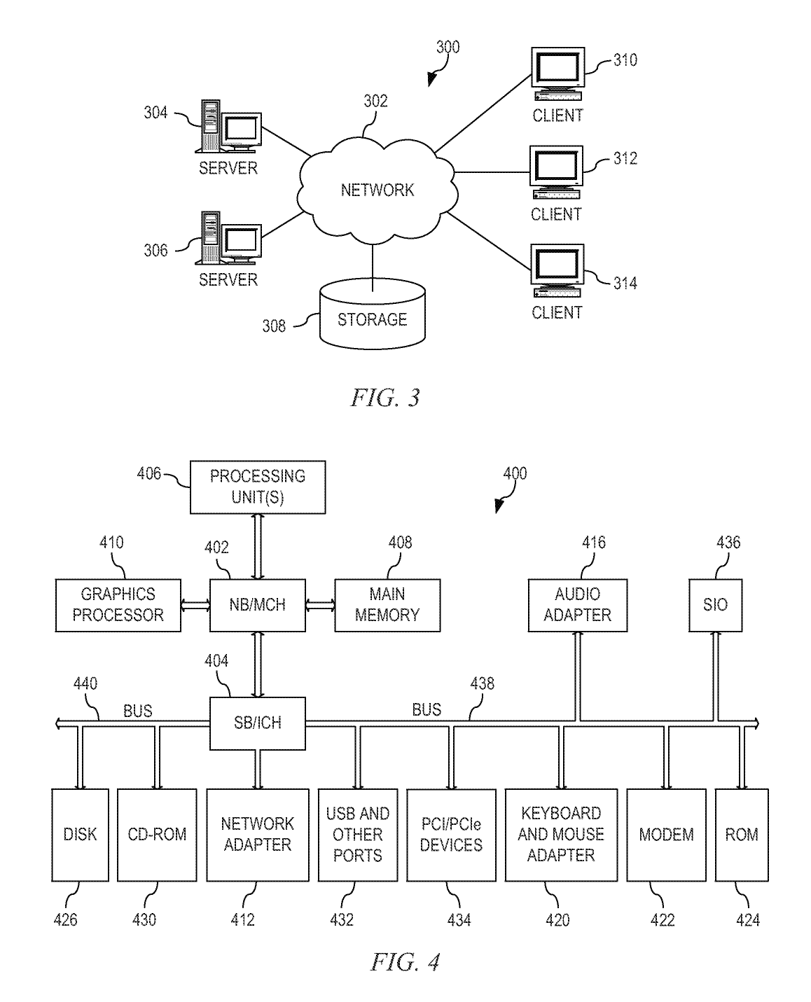

Thus, the illustrative embodiments may be utilized in many different types of data processing environments. In order to provide a context for the description of the specific elements and functionality of the illustrative embodiments, FIGS. 3 and 4 are provided hereafter as example environments in which aspects of the illustrative embodiments may be implemented. It should be appreciated that FIGS. 3 and 4 are only examples and are not intended to assert or imply any limitation with regard to the environments in which aspects or embodiments of the present invention may be implemented. Many modifications to the depicted environments may be made without departing from the spirit and scope of the present invention.

FIG. 3 depicts a pictorial representation of an example distributed data processing system in which aspects of the illustrative embodiments may be implemented. Distributed data processing system 300 may include a network of computers in which aspects of the illustrative embodiments may be implemented. The distributed data processing system 300 contains at least one network 302, which is the medium used to provide communication links between various devices and computers connected together within distributed data processing system 300. The network 302 may include connections, such as wire, wireless communication links, or fiber optic cables.

In the depicted example, server 304 and server 306 are connected to network 302 along with storage unit 308. In addition, clients 310, 312, and 314 are also connected to network 302. These clients 310, 312, and 314 may be, for example, personal computers, network computers, or the like. In the depicted example, server 304 provides data, such as boot files, operating system images, and applications to the clients 310, 312, and 314. Clients 310, 312, and 314 are clients to server 304 in the depicted example. Distributed data processing system 300 may include additional servers, clients, and other devices not shown.

In the depicted example, distributed data processing system 300 is the Internet with network 302 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, the distributed data processing system 300 may also be implemented to include a number of different types of networks, such as for example, an intranet, a local area network (LAN), a wide area network (WAN), or the like. As stated above, FIG. 3 is intended as an example, not as an architectural limitation for different embodiments of the present invention, and therefore, the particular elements shown in FIG. 3 should not be considered limiting with regard to the environments in which the illustrative embodiments of the present invention may be implemented.

FIG. 4 is a block diagram of an example data processing system in which aspects of the illustrative embodiments may be implemented. Data processing system 400 is an example of a computer, such as client 310 in FIG. 3, in which computer usable code or instructions implementing the processes for illustrative embodiments of the present invention may be located.

In the depicted example, data processing system 400 employs a hub architecture including north bridge and memory controller hub (NB/MCH) 402 and south bridge and input/output (I/O) controller hub (SB/ICH) 404. Processing unit 406, main memory 408, and graphics processor 410 are connected to NB/MCH 402. Graphics processor 410 may be connected to NB/MCH 402 through an accelerated graphics port (AGP).

In the depicted example, local area network (LAN) adapter 412 connects to SB/ICH 404. Audio adapter 416, keyboard and mouse adapter 420, modem 422, read only memory (ROM) 424, hard disk drive (HDD) 426, CD-ROM drive 430, universal serial bus (USB) ports and other communication ports 432, and PCI/PCIe devices 434 connect to SB/ICH 404 through bus 438 and bus 440. PCI/PCIe devices may include, for example, Ethernet adapters, add-in cards, and PC cards for notebook computers. PCI uses a card bus controller, while PCIe does not. ROM 424 may be, for example, a flash basic input/output system (BIOS).

HDD 426 and CD-ROM drive 430 connect to SB/ICH 404 through bus 440. HDD 426 and CD-ROM drive 430 may use, for example, an integrated drive electronics (IDE) or serial advanced technology attachment (SATA) interface. Super I/O (SIO) device 436 may be connected to SB/ICH 404.

An operating system runs on processing unit 406. The operating system coordinates and provides control of various components within the data processing system 400 in FIG. 4. As a client, the operating system may be a commercially available operating system such as Microsoft® Windows 7®. An object-oriented programming system, such as the Java™ programming system, may run in conjunction with the operating system and provides calls to the operating system from Java™ programs or applications executing on data processing system 400.

As a server, data processing system 400 may be, for example, an IBM® eServer™ System p® computer system, running the Advanced Interactive Executive (AIX®) operating system or the LINUX® operating system. Data processing system 400 may be a symmetric multiprocessor (SMP) system including a plurality of processors in processing unit 406. Alternatively, a single processor system may be employed.

Instructions for the operating system, the object-oriented programming system, and applications or programs are located on storage devices, such as HDD 426, and may be loaded into main memory 408 for execution by processing unit 406. The processes for illustrative embodiments of the present invention may be performed by processing unit 406 using computer usable program code, which may be located in a memory such as, for example, main memory 408, ROM 424, or in one or more peripheral devices 426 and 430, for example.

A bus system, such as bus 438 or bus 440 as shown in FIG. 4, may be comprised of one or more buses. Of course, the bus system may be implemented using any type of communication fabric or architecture that provides for a transfer of data between different components or devices attached to the fabric or architecture. A communication unit, such as modem 422 or network adapter 412 of FIG. 4, may include one or more devices used to transmit and receive data. A memory may be, for example, main memory 408, ROM 424, or a cache such as found in NB/MCH 402 in FIG. 4.

Those of ordinary skill in the art will appreciate that the hardware in FIGS. 3 and 4 may vary depending on the implementation. Other internal hardware or peripheral devices, such as flash memory, equivalent non-volatile memory, or optical disk drives and the like, may be used in addition to or in place of the hardware depicted in FIGS. 3 and 4. Also, the processes of the illustrative embodiments may be applied to a multiprocessor data processing system, other than the SMP system mentioned previously, without departing from the spirit and scope of the present invention.

Moreover, the data processing system 400 may take the form of any of a number of different data processing systems including client computing devices, server computing devices, a tablet computer, laptop computer, telephone or other communication device, a personal digital assistant (PDA), or the like. In some illustrative examples, data processing system 400 may be a portable computing device that is configured with flash memory to provide non-volatile memory for storing operating system files and/or user-generated data, for example. Essentially, data processing system 400 may be any known or later developed data processing system without architectural limitation.

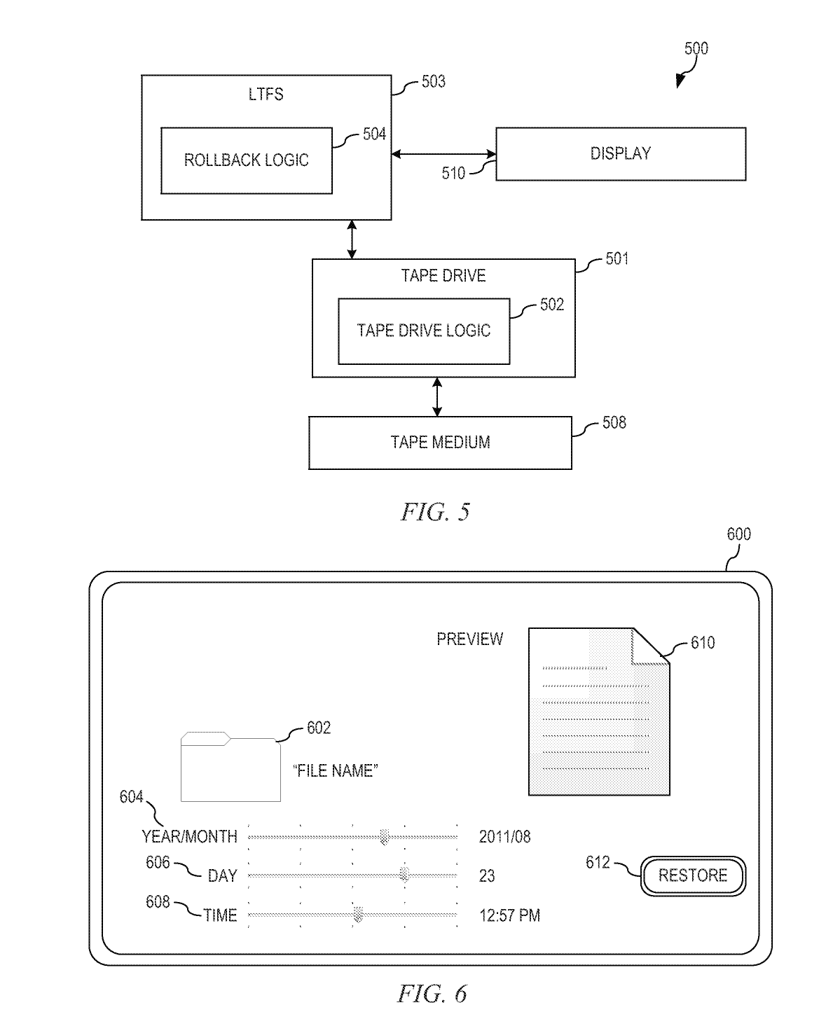

FIG. 5 depicts a functional block diagram of a rollback mechanism for recovering content of a file on a linear tape medium back to a previous state at a user-identified point in time in accordance with an illustrative embodiment. Data processing system 500 comprises tape drive 501 and Linear Tape File System (LTFS) 503, where tape drive 501 comprises tape drive logic 502 and LTFS 503 comprises rollback logic 504. Tape drive logic 502 interacts with LTFS 503 to execute data-read and data-write operations to tape medium 508. As described previously, at predetermined time intervals and/or as tape drive logic 502 writes data to tape medium 508, tape drive logic 502 generates an index associated with the time interval and/or an index associated with the data that is written. This index comprises unique-to-file information identifying a file name, data/time written, one or more starting wrap positions and engine wrap positions, one or more head (start) positions of the file and tail (end) positions of the file as written to tape medium 508 using longitudinal position (lpos) information (respective of the changes made to the file), or the like. Tape drive logic 502 utilizes this index information to access files stored on tape medium 508, which may be a LTFS formatted media, similar to accessing files stored on other forms of storage media such as hard disks, removable flash drives, or the like. Tape drive logic 502 writes data linearly to tape medium 508, such that a new write operation will never be performed at a position where a previous write operation has been performed. For example, even when a file that is already recorded on tape medium 508 is changed such that a middle portion of the file is deleted and a new portion has replaced the deleted portion, tape drive logic 502 records:
1) starting wrap position of original file, head position of original file, tail position of original file just prior to deleted portion, and ending wrap position of original file just prior to deleted portion;
2) starting wrap position of added data, head position of the added data, tail position of the added data, and ending wrap position of the added data; and
3) starting wrap position of original file just after deleted portion, head position of original file just after deleted portion, tail position of original file, and ending wrap position of original file.
   Thus, tape drive logic 502 does not delete the original file, rather, tape drive logic 502 only writes the new portion of the file to tape medium 508 and updates the associated portion of the index to reflect the file properties. Thus, in tape medium 508, the number of points in time to which it is possible to return to a previous version of the file increases without any specific upper limit depending on how tape medium 508 is used.

In accordance with the illustrative embodiments, in response to a request to view previous versions of a particular file, rollback logic 504 starts a process of reading all of the indexes of tape medium 508 starting with the most recent index. Rollback logic 504 reads the most recent index (n) and the index just prior to the most recent index (n−1), i.e. the preceding index. For the most recent index (n), rollback logic 504 determines whether the most recent index (n) and the n−1 index comprise any information associated with the file. If rollback logic 504 determines that there is information associated with the file in the most recent index (n) and the n−1 index, rollback logic 504 determines whether the information associated with the file in the most recent index (n) is different (indicating a change) from information associated with the file in the n−1 index. If the information associated with the file is different, then rollback logic 504 records the information as a version of the file along with an identifying date and time of the index.

If rollback logic 504 determines that there is no information associated with the file in the most recent index (n) or if the information associated with the file in the most recent index (n) is not different (indicating a change) from information associated with the file in the n−1 index, rollback logic 504 determines whether there is another index preceding the n−1 index. That is, rollback logic 504 determines whether there is an n−2 index. If there is an n−2 index, then rollback logic 504 determines whether the n−1 index and the n−2 index comprise any information associated with the file. If rollback logic 504 determines that there is information associated with the file in the n−1 index and the n−2 index, rollback logic 504 determines whether the information associated with the file in the n−1 index is different (indicating a change) from information associated with the file the n−2 index. If the information associated with the file is different, then rollback logic 504 records the information as a version of the file along with an identifying date and time of the index. If rollback logic 504 determines that there is no information associated with the file in the n−1 index or if the information associated with the file in the n−1 index is not different (indicating a change) from information associated with the file in the n−2 index, rollback logic 504 repeats the process until the initial index is reached. As is illustrated, only when a change is detected does rollback logic 504 record the information about the file, such that only the information associated with changes in the file are recorded as changed file versions.

As described above, since indexes of a tape medium are updated at regular time intervals, then, if the tape medium were written every hour of every day for a year, there may be 8,760 indexes on the tape medium. Rollback logic 504 reduces a user having to review every index to identify a previous version of the file by identifying only those indexes and information where the file changed or was added to tape medium 508. Thus, if a file was added to tape medium 508 and was updated only 14 times over a year, rollback logic 504 identifies the 15 indexes where the file changes and the information associated with the file indicating the change.

Further, in response to the request to view previous versions of a particular file, rollback logic 504 presents the information to the user via a graphical user interface in display 510 as a combination of components for a user to easily select an arbitrary previous point in time for recovery. That is, rollback logic 504 may present the different versions as a combination of three sliders where time is split into three different time scales. Each of the three different time scales is assigned to the corresponding one of the three sliders. The first slider may be used for selection in the time scale of “year/month.” The second slider may be used for selection in the time scale of “day.” The third slider may be used for selection in the time scale of “time.” With the use of these sliders, the user may select a returnable point in time only. By the user selecting a combination of year/month, day, and time, rollback logic 504 is able to identify the version of the file associated with that point in time as the version to restore. Additionally, once the user has selected a combination of year/month, day, and time, in addition to identifying the version of the file associated with that point in time as the version to restore, rollback logic 504 may also provide a preview of the identified version of the file that may be previewed by the user prior to actually restoring the file. That is, by the user selecting the preview of the file at the combination of year/month, day, and time, tape drive logic 502 may read the file based on the selected index information and provide a preview of the file to the user based on that information. Finally, if the user is satisfied that the identified version of the file is the version of the file the user wants to restore, rollback logic 504 provides a restore button for the user to indicate the selection.

FIG. 6 depicts an exemplary graphical user interface provided by rollback logic 504 of FIG. 5 in accordance with an illustrative embodiment. Graphical user interface 600 comprises an indication 602 of the file by name for which the rollback logic has identified one or more unique versions on a tape medium. Graphical user interface 600 further comprises three different sliders 604, 606, and 608. Slider 604 provides for a selection in a time scale of “year/month.” Slider 606 provides for a selection in a time scale of “day.” Slider 608 provides for a selection in a time scale of “time.” Based on the selection made by a user using sliders 604, 606, and 608, the rollback logic identifies the version of the file associated with that point in time as the version of the file to restore, which is presented as preview 610. If the user decides that the previewed version of the file is the version that the user wants restored, graphical user interface 600 also provides restore button 612, which, when selected, causes the rollback logic to restore the file to the selected version.

The above aspects and advantages of the illustrative embodiments of the present invention will be described in greater detail hereafter with reference to the accompanying figures. It should be appreciated that the figures are only intended to be illustrative of exemplary embodiments of the present invention. The present invention may encompass aspects, embodiments, and modifications to the depicted exemplary embodiments not explicitly shown in the figures but would be readily apparent to those of ordinary skill in the art in view of the present description of the illustrative embodiments.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in any one or more computer readable medium(s) having computer usable program code embodied thereon.

Any combination of one or more computer readable medium(s) may be utilized. The computer readable medium may be a computer readable signal medium or a computer readable storage medium. A computer readable storage medium is a system, apparatus, or device of an electronic, magnetic, optical, electromagnetic, or semiconductor nature, any suitable combination of the foregoing, or equivalents thereof. More specific examples (a non-exhaustive list) of the computer readable storage medium would include the following: an electrical device having a storage capability, a portable computer diskette, a hard disk, a random access memory (RAM), a read-only memory (ROM), an erasable programmable read-only memory (EPROM or Flash memory), an optical fiber based device, a portable compact disc read-only memory (CDROM), an optical storage device, a magnetic storage device, or any suitable combination of the foregoing. In the context of this document, a computer readable storage medium is any tangible medium that can contain or store a program for use by, or in connection with, an instruction execution system, apparatus, or device.

In some illustrative embodiments, the computer readable medium is a non-transitory computer readable medium. A non-transitory computer readable medium is any medium that is not a disembodied signal or propagation wave, i.e. pure signal or propagation wave per se. A non-transitory computer readable medium may utilize signals and propagation waves, but is not the signal or propagation wave itself. Thus, for example, various forms of memory devices, and other types of systems, devices, or apparatus, that utilize signals in any way, such as, for example, to maintain their state, may be considered to be non-transitory computer readable media within the scope of the present description.

A computer readable signal medium, on the other hand, may include a propagated data signal with computer readable program code embodied therein, for example, in a baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Similarly, a computer readable storage medium is any computer readable medium that is not a computer readable signal medium.

Computer code embodied on a computer readable medium may be transmitted using any appropriate medium, including but not limited to wireless, wireline, optical fiber cable, radio frequency (RF), etc., or any suitable combination thereof.

Computer program code for carrying out operations for aspects of the present invention may be written in any combination of one or more programming languages, including an object oriented programming language such as Java™, Smalltalk™, C++, or the like, and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to the illustrative embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions that implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus, or other devices to produce a computer implemented process such that the instructions which execute on the computer or other programmable apparatus provide processes for implementing the functions/acts specified in the flowchart and/or block diagram block or blocks.

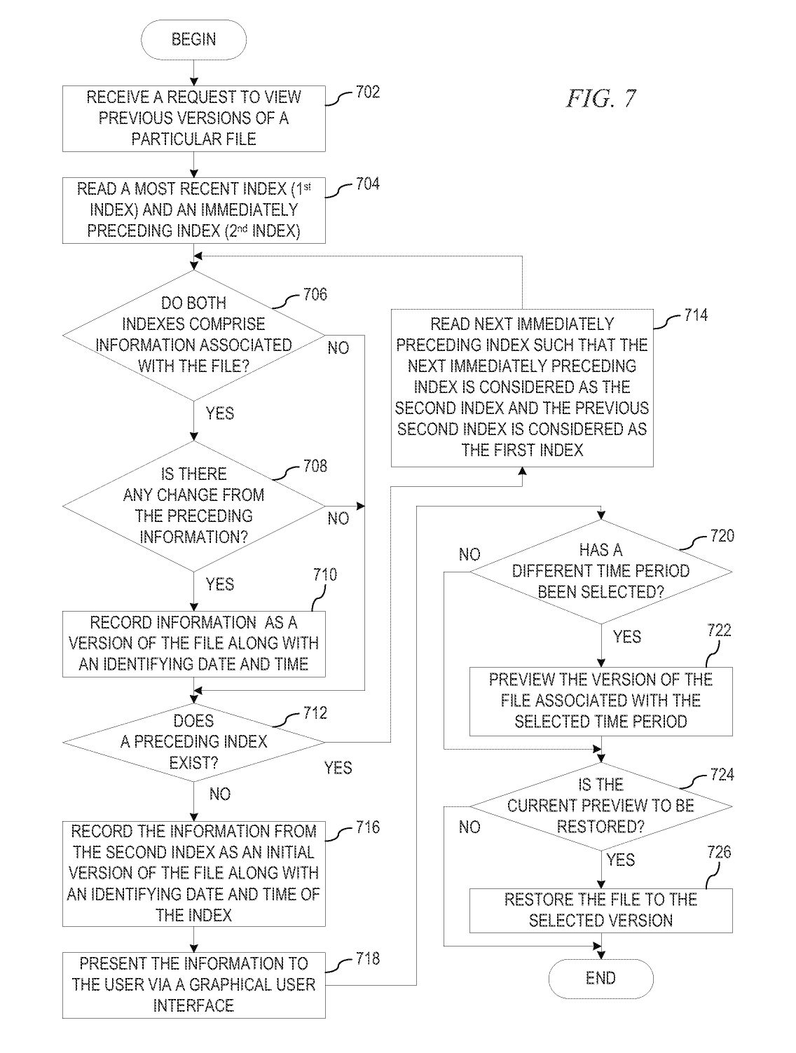

FIG. 7 depicts a flowchart of the operation performed by a rollback mechanism, such as rollback logic 504 of FIG. 5, in accordance with an illustrative embodiment. As the operation begins, the rollback mechanism receives a request to view previous versions of a particular file (step 702). The rollback logic reads a most recent index (a first index or n) and an immediately preceding index (a second index or n−1) (step 704). The rollback mechanism determines whether the first index and the second index comprise any information associated with the file (step 706). If at step 706 the first index and the second index comprise information associated with the file, the rollback mechanism determines whether the information associated with the file in the first index is different (indicating a change) from information associated with the file in the second index (step 708). If at step 708 the information associated with the file is different, then the rollback mechanism records the information from the first index as a version of the file along with an identifying date and time of the index (step 710).

If at step 706 either the first or the second index fail to comprise information about the file, if at step 708 the information associated with the file fails to be different, or from step 710, the rollback mechanism determines if there is another index preceding the current second index (step 712). If at step 712 there is another index preceding the current second index, the rollback mechanism reads a next immediately preceding index (n−2) such that, in the comparison that is performed by the rollback mechanism, the next immediately preceding index (n−2) is considered as the second index and the previous second index is considered as the first index (step 714), with the operation returning to step 706 thereafter. If at step 712 there is not another index, the rollback mechanism records the information from the second index as an initial version of the file along with an identifying date and time of the index (step 716).

The rollback mechanism then presents the information to the user via a graphical user interface along with a preview of the most current version of the file, such as is illustrated in graphical user interface 600 of FIG. 6 (step 718), in a display. The rollback mechanism then determines whether the user has changed one or more sliders to reflect a combination of year/month, day, and time that is different from a current year/month, day, and time of a currently previewed version of the file (step 720). If at step 720 the user has selected a different combination of year/month, day, and time, then rollback mechanism previews the version of the file associated with the selected year/month, day, and time (step 722). From step 722 or if at step 720 the user has not selected a different combination of year/month, day, and time, the rollback mechanism determines whether the user has selected the current previewed version to be restored (step 724). If at step 724 the user has not selected the current previewed version to be restored, the operation ends. If at step 724 the user has selected the current previewed version to be restored, the rollback mechanism restores the file to the selected version (step 726). With the operation ending thereafter.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Thus, the illustrative embodiments provide mechanisms for a rollback mechanism for linear tape file systems that provide the user with an easy means to recover the content of a file back to a previous state at a user-identified point in time. The mechanism utilizes a plurality of components that are graphically presented to the user that allows the user to select from a plurality of year/month/day/time ranges to which a file can be recovered. With each year/month/day/time range available to be selected by the user, there is a different version of the file, which may be provided as a preview to the user. With the selection of a version of the file at one of the year/month/day/time ranges, the mechanism of the illustrative embodiments returns the file to the previous version by updating the index to reflect the selected previous state.

As noted above, it should be appreciated that the illustrative embodiments may take the form of an entirely hardware embodiment, an entirely software embodiment or an embodiment containing both hardware and software elements. In one example embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method, in a data processing system, for restoring a file recorded on a storage medium to a previous version of the file, the method comprising:
presenting at least two different versions of a file recorded on the storage medium to a user via a graphical user interface, wherein the at least two different versions of the file are identified from at least two different indexes recorded on the storage medium; and
responsive to a selection of the previous version of the file from the at least two different versions of the file, restoring the file to the previous version of the file by recording a new index on the storage medium for the file that matches an index of the file associated with the previous version of the file.

2. The method of claim 1, wherein the at least two different versions of the file are identified by the method comprising:
identifying a first index and a second index on the storage medium, wherein the second index immediately precedes the first index;
responsive to both the first index and the second index comprising information pertaining to the file, comparing first information in the first index to second information in the second index;
responsive to the first information differing from the second information, recording the first information as one version of the file;
identifying a third index on the storage medium, wherein the third index immediately precedes the second index;
responsive to the third index comprising information pertaining to the file, comparing the second information in the second index to third information in the third index; and
responsive to the second information differing from the third information, recording the second information as another version of the file.

3. The method of claim 1, further comprising:
performing a comparison between each index and an immediately preceding index on the storage medium until all versions of the file are identified; and
responsive to information in the index and information in the immediately preceding index differing, recording the information in the index as another version of the file.

4. The method of claim 1, wherein the selection of the previous version of the file from the at least two different versions of the file is identified based on the user moving at least one of a set of two or more graphical user interface (GUI) components in the graphical user interface to indicate the previous version of the file.

5. The method of claim 4, wherein the GUI components are sliders.

6. The method of claim 4, wherein the set of two or more graphical user interface (GUI) components comprises a first slider indicating a year and month, a second slider indicating a day, and a third slider indicating a time.

7. The method of claim 1, further comprising:
responsive to the selection of the previous version of the file from the at least two different versions of the file, previewing the previous version of the file via the graphical user interface using the index of the file associated with the previous version of the file.

8. The method of claim 1, wherein the storage medium is a tape medium and wherein the tape medium is a Linear Tape File System (LTFS) formatted tape medium.

9. A computer program product comprising a computer readable storage medium having a computer readable program stored therein, wherein the computer readable program, when executed on a computing device, causes the computing device to:
present at least two different versions of a file recorded on the storage medium to a user via a graphical user interface, wherein the at least two different versions of the file are identified from at least two different indexes recorded on the storage medium; and
responsive to a selection of the previous version of the file from the at least two different versions of the file, restore the file to the previous version of the file by recording a new index on the storage medium for the file that matches an index of the file associated with the previous version of the file.

10. The computer program product of claim 9, wherein the at least two different versions of the file are identified by the computer readable program causing the computing device to:
identify a first index and a second index on the storage medium, wherein the second index immediately precedes the first index;
responsive to both the first index and the second index comprising information pertaining to the file, compare first information in the first index to second information in the second index;
responsive to the first information differing from the second information, record the first information as one version of the file;
identify a third index on the storage medium, wherein the third index immediately precedes the second index;
responsive to the third index comprising information pertaining to the file, compare the second information in the second index to third information in the third index; and
responsive to the second information differing from the third information, record the second information as another version of the file.

11. The computer program product of claim 9, wherein the computer readable program further causes the computing device to:
perform a comparison between each index and an immediately preceding index on the storage medium until all versions of the file are identified; and
responsive to information in the index and information in the immediately preceding index differing, record the information in the index as another version of the file.

12. The computer program product of claim 9, wherein the selection of the previous version of the file from the at least two different versions of the file is identified based on the user moving at least one of a set of two or more graphical user interface (GUI) components in the graphical user interface to indicate the previous version of the file.

13. The computer program product of claim 9, wherein the computer readable program further causes the computing device to:
responsive to the selection of the previous version of the file from the at least two different versions of the file, previewing the previous version of the file via the graphical user interface using the index of the file associated with the previous version of the file.

14. The computer program product of claim 9, wherein the storage medium is a tape medium and wherein the tape medium is a Linear Tape File System (LTFS) formatted tape medium.

15. An apparatus comprising:
a processor; and
a memory coupled to the processor, wherein the memory comprises instructions which, when executed by the processor, cause the processor to:
present at least two different versions of a file recorded on the storage medium to a user via a graphical user interface, wherein the at least two different versions of the file are identified from at least two different indexes recorded on the storage medium; and
responsive to a selection of the previous version of the file from the at least two different versions of the file, restore the file to the previous version of the file by recording a new index on the storage medium for the file that matches an index of the file associated with the previous version of the file.

16. The apparatus of claim 15, wherein the at least two different versions of the file are identified by the instructions causing the processor to:
identify a first index and a second index on the storage medium, wherein the second index immediately precedes the first index;
responsive to both the first index and the second index comprising information pertaining to the file, compare first information in the first index to second information in the second index;
responsive to the first information differing from the second information, record the first information as one version of the file;
identify a third index on the storage medium, wherein the third index immediately precedes the second index;
responsive to the third index comprising information pertaining to the file, compare the second information in the second index to third information in the third index; and
responsive to the second information differing from the third information, record the second information as another version of the file.

17. The apparatus of claim 15, wherein the instructions further cause the processor to:
perform a comparison between each index and an immediately preceding index on the storage medium until all versions of the file are identified; and
responsive to information in the index and information in the immediately preceding index differing, record the information in the index as another version of the file.

18. The apparatus of claim 15, wherein the selection of the previous version of the file from the at least two different versions of the file is identified based on the user moving at least one of a set of two or more graphical user interface (GUI) components in the graphical user interface to indicate the previous version of the file.

19. The apparatus of claim 15, wherein the instructions further cause the processor to:
responsive to the selection of the previous version of the file from the at least two different versions of the file, previewing the previous version of the file via the graphical user interface using the index of the file associated with the previous version of the file.

20. The apparatus of claim 15, wherein the storage medium is a tape medium and wherein the tape medium is a Linear Tape File System (LTFS) formatted tape medium.
